(19) United States
(12) Patent Application Publication
(10) Pub. No.: US 2017/0093074 A1
(43) Pub. Date: Mar. 30, 2017

(54) CONNECTOR

(71) Applicant: YAZAKI CORPORATION, Tokyo (JP)

(72) Inventor: Masanori NAGASAWA, Shizuoka (JP)

(73) Assignee: YAZAKI CORPORATION, Tokyo (JP)

(21) Appl. No.: 15/374,162

(22) Filed: Dec. 9, 2016

Related U.S. Application Data
(63) Continuation of application No. 14/757,427, filed on Dec. 23, 2015.

(30) Foreign Application Priority Data
Dec. 24, 2014 (JP) 2014-260338
Dec. 24, 2014 (JP) 2014-260339

(51) Int. Cl. H01R 13/405; H01R 13/631; H01R 13/50

(52) U.S. Cl. CPC H01R 13/405; H01R 13/50; H01R 13/631

(57) ABSTRACT

A connector includes: an electrically conductive busbar; a holder that holds the busbar; and a housing that houses therein the holder and the busbar held in the holder, the housing being integrally molded with the holder and the busbar, having insulative property, and exposing an end of the busbar. The holder includes a rib that position the busbar and that form lightened portion in the housing during molding of the housing. Because the rib forms the lightened portion in the housing, the connector can prevent sink and void from occurring in the housing during the molding of the housing. As a result, the connector can, for example, improve moldability without the need to change a desired appearance shape.

### CROSS-REFERENCE TO RELATED APPLICATION(S)

The present application is a continuation of pending U.S. application Ser. No. 14/757,427, filed Dec. 23, 2015 which claims priority to and incorporates by reference the entire contents of Japanese Patent Application No. 2014-260338 filed in Japan on Dec. 24, 2014 and Japanese Patent Application No. 2014-260339 filed in Japan on Dec. 24, 2014.

### BACKGROUND OF THE INVENTION

1. Field of the Invention

The present invention relates to a connector.

2. Description of the Related Art

As a conventional connector, Japanese Patent Application Laid-open No. 2012-164520, for example, discloses a relay connector molded through insert molding of a holder assembly that includes a terminal held in a holder.

In the relay connector disclosed in Japanese Patent Application Laid-open No. 2012-164520, a busbar is fixed by the holder for insert molding, for example. Housing moldability, however, still needs improvements.

Japanese Patent Application Laid-open No. H08-045627, for example, discloses, as another conventional connector, a relay connector that includes at least one coupling terminal unit, a first housing, and a second housing. More specifically, the coupling terminal unit includes a female terminal having a first end directly coupled to a first end of a male terminal strip. The first housing includes a female terminal mounting portion in which the female terminal of the coupling terminal is housed and mounted. The second housing is connected in a row arrangement to the first housing. The second housing includes a housing chamber in which the male terminal strip of the coupling terminal unit is housed and mounted.

In the relay connector disclosed in Japanese Patent Application Laid-open No. H08-045627, the coupling terminal unit is shaped as to extend linearly. For reasons, for example, of a limited installation site, however, a need exists for a connector that includes a coupling terminal bent into, for example, an L-shape to allow electrical connections to be made to mating members on both sides of the coupling terminal. The connector including the coupling terminal bent into an L-shape typically defies a structure in which the bent coupling terminal is fitted inside a previously molded housing and fixed using, for example, a lance. A specific arrangement is thus yet to be established.

### SUMMARY OF THE INVENTION

In view of the circumstances described above, the present invention aims to provide a connector capable of improving moldability.

In addition, the present invention aims to provide a connector capable of electrically connecting mating members across both sides of a bent portion disposed inside a housing.

In order to achieve the above mentioned object, according to one aspect of the present invention, a connector includes a busbar having electrical conductivity; a holder configured to hold the busbar; and a housing configured to house therein the holder and the busbar held in the holder, the housing being integrally molded with the holder and the busbar, having insulative property, and exposing an end of the busbar, wherein the holder includes a rib that position the busbar and that form a lightened portion in the housing during molding of the housing, the lightened portion having a wall thickness smaller than other portions of the housing.

According to another aspect of the present invention, in the connector, it is possible to further include that a connecting unit having electrical conductivity; and a holding member configured to hold the connecting unit, wherein the busbar includes a plurality of busbars, each busbar including a first male terminal and a second male terminal integrally formed with each other via a bent portion, the holder holds the plurality of busbars such that the first male terminal is arrayed on a first virtual plane and the second male terminal is arrayed on a second virtual plane that is orthogonal to the first virtual plane, the housing has a first fitting space in which the first male terminal is exposed and into which a first mating member to be electrically connected to the first male terminal can be fitted, and a second fitting space in which the second male terminal is exposed, the connecting unit includes a first female terminal into which a second mating member is inserted and to which the second mating member is electrically connected, and a second female terminal into which the second male terminal is inserted and to which the second male terminal is electrically connected, the first female terminal being integrally formed with the second female terminal, and the holding member fits into the second fitting space and holds the connecting unit in a condition in which the second male terminal is electrically connected to the second female terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a schematic configuration of connectors according to first and second embodiments of the present invention;

FIG. 2 is a sectional view of the connector according to the first embodiment, taken along line A-A;

FIG. 3 is an exploded perspective view of a busbar assembly of the connector according to the first embodiment;

FIG. 4 is a perspective view of the busbar assembly of the connector according to the first embodiment;

FIG. 5 is a view from the direction of arrow B illustrated in FIG. 1;

FIG. 6 is a view from the direction of arrow C illustrated in FIG. 1;

FIG. 7 is an exploded perspective view of a female assembly of the connectors according to the first and second embodiments;

FIG. 8 is a perspective view of the female assembly of the connectors according to the first and second embodiments;

FIG. 9 is a sectional view of the connector according to the second embodiment, taken along line A-A;

FIG. 10 is an exploded perspective view of a busbar assembly of the connector according to the second embodiment; and

FIG. 11 is a perspective view of the busbar assembly of the connector according to the second embodiment.

### DETAILED DESCRIPTION OF THE PREFERRED EMBODIMENTS

The following describes in detail first and second embodiments of the present invention with reference to the accompanying drawings. It is to be understood that the first and second embodiments are illustrative and not restrictive in all aspects. The components in the first and second embodiments include components that can be readily replaced by those skilled in the art or that are substantially identical.

### First Embodiment

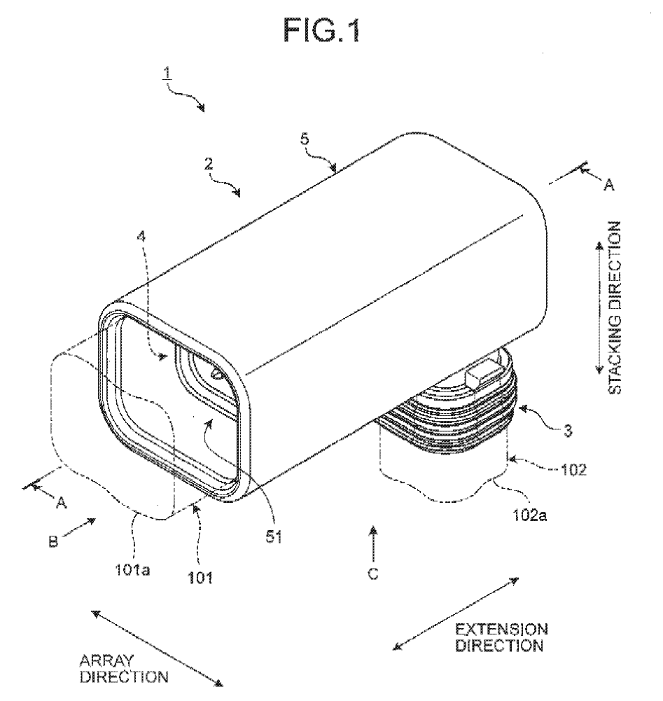

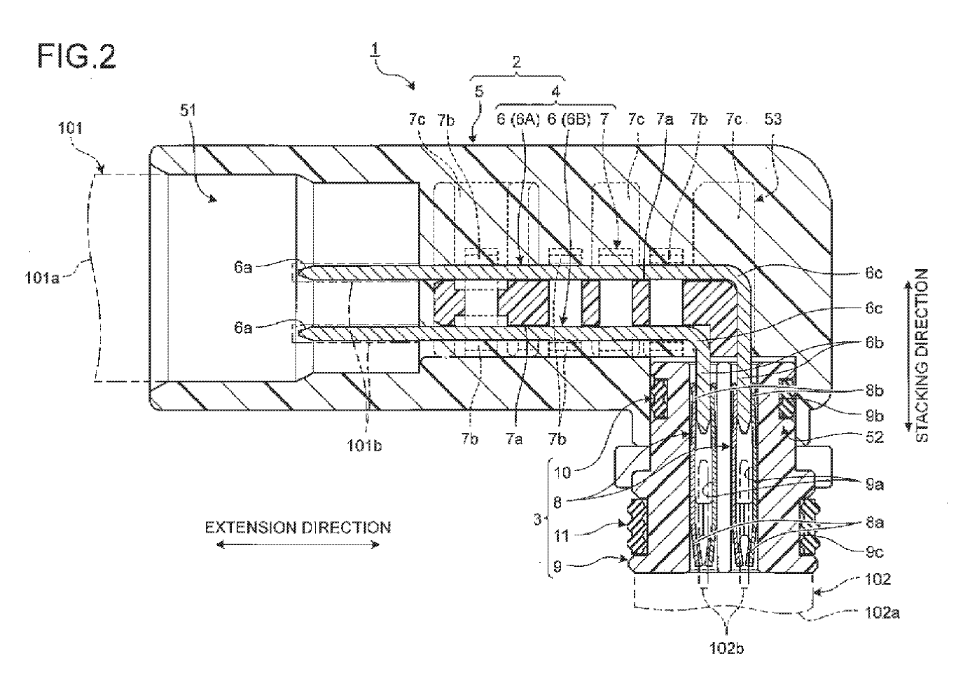

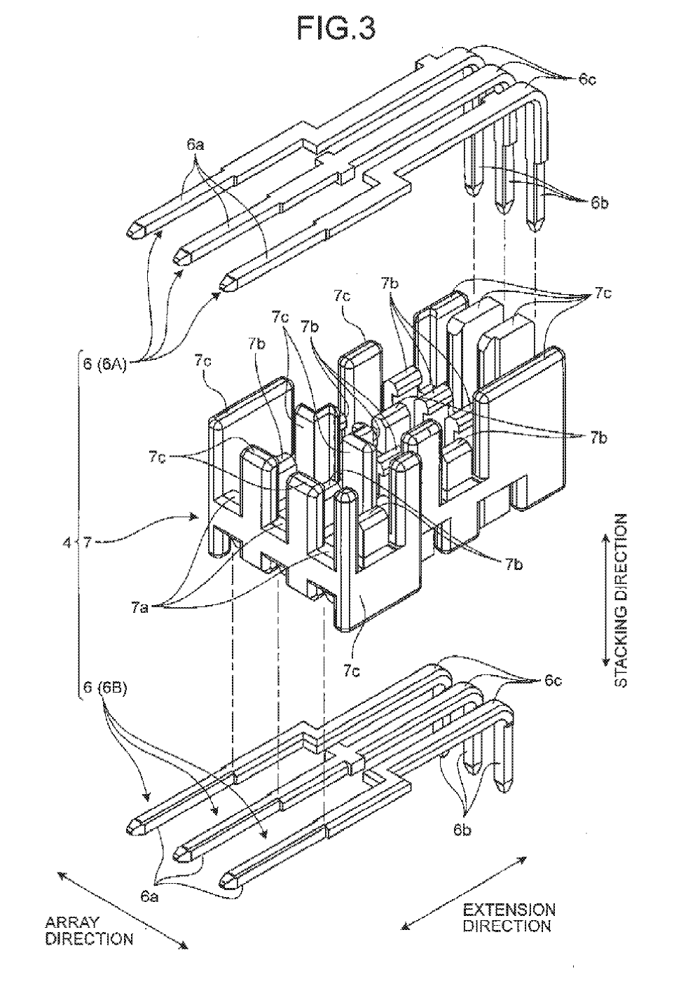

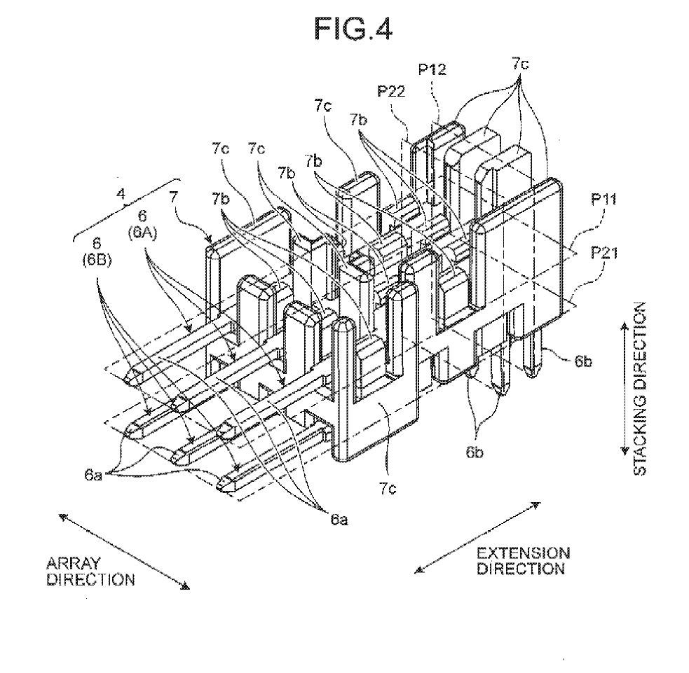

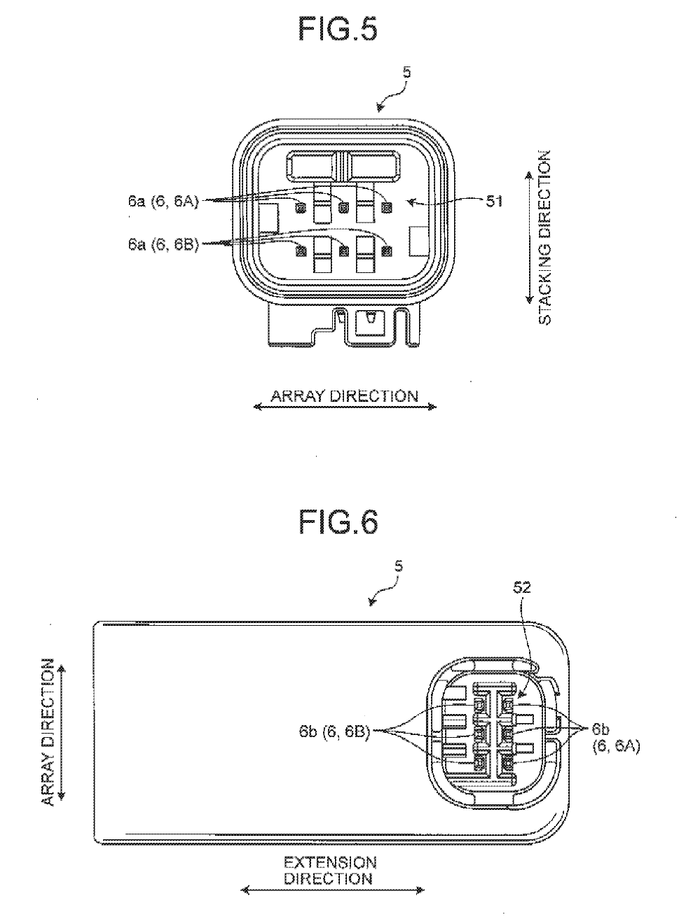

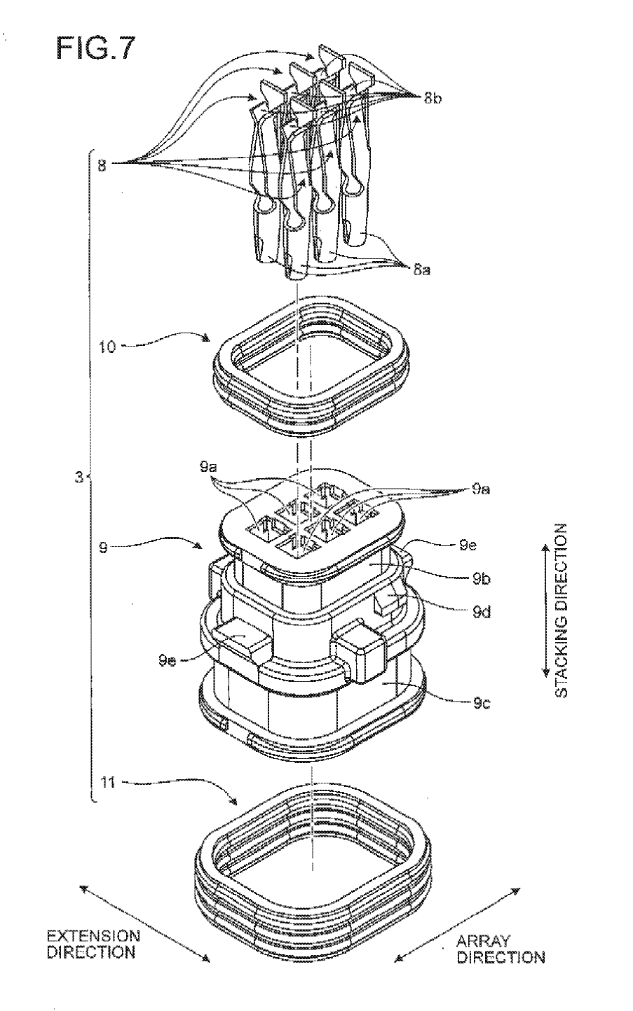

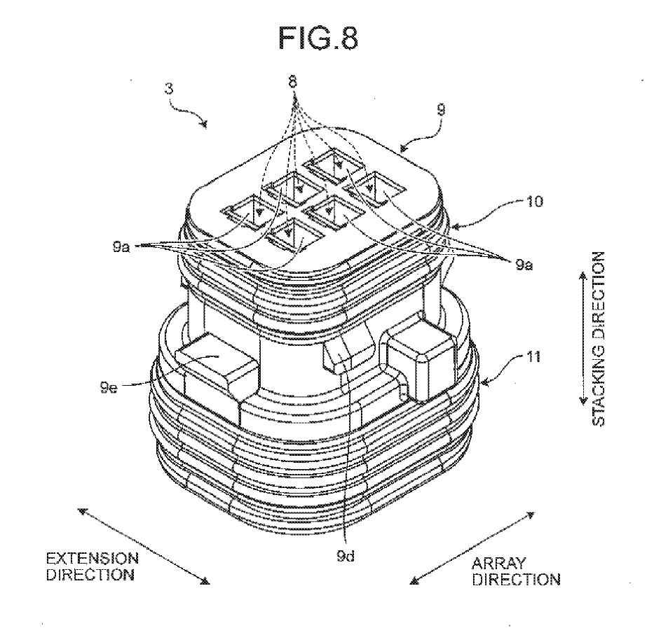

FIG. 1 is a perspective view of a schematic configuration of a connector according to a first embodiment of the present invention. FIG. 2 is a sectional view of the connector according to the first embodiment, taken along line A-A. FIG. 3 is an exploded perspective view of a busbar assembly of the connector according to the first embodiment. FIG. 4 is a perspective view of the busbar assembly of the connector according to the first embodiment. FIG. 5 is a view from the direction of arrow B illustrated in FIG. 1. FIG. 6 is a view from the direction of arrow C illustrated in FIG. 1. FIG. 7 is an exploded perspective view of a female assembly of the connector according to the first embodiment. FIG. 8 is a perspective view of the female assembly of the connector according to the first embodiment.

This connector 1 illustrated in FIGS. 1 and 2 according to the first embodiment is what is called a relay connector for use in connecting a wire harness to an electric device used in, for example, an automobile. The connector 1 in the first embodiment is a male female relay connector bent into a substantially L-shape, electrically connecting to a first mating member 101 and a second mating member 102 on both sides of a bent portion 6c disposed inside a housing (a male housing 5). The first mating member 101 is, for example, a female connector connected to a distal end of a wire of a wire harness. The first mating member 101 includes a connector housing 101a and a plurality of female terminals 101b supported in the connector housing 101a. The second mating member 102 is, for example, a connecting portion disposed in an electric device. The second mating member 102 includes a plurality of male terminals 102b supported in a housing 102a of the electric device.

Specifically, the connector 1 includes a male housing assembly (hereinafter may be referred to simply as a “male assembly”) 2, and a female housing assembly (hereinafter may be referred to simply as a “female assembly”) 3.

The male assembly 2 includes a busbar assembly 4 and the male housing 5. The busbar assembly 4 is disposed inside the male housing 5 to integrally form the male assembly 2.

As illustrated in FIGS. 2, 3, and 4, the busbar assembly 4 includes a plurality of busbars 6 and a holder 7. The busbars 6 are held in the holder 7 to constitute the busbar assembly 4.

Each of the busbars 6 includes a first male terminal 6a and a second male terminal 6b integrally formed with each other via the bent portion 6c. Each busbar 6 is electrically conductive. Each busbar 6 is formed generally of, for example, a conductive metal. Conductive plating, for example, is applied to the surface of each busbar 6. In each busbar 6, a rectangular wire rod formed into a bar shape is bent into a substantially L-shape by, for example, press-working to form the bent portion 6c. The first male terminal 6a is formed on an end of a first side of each busbar 6 and the second male terminal 6b is formed on an end on a second side of each busbar 6. The bent portion 6c is disposed between the first male terminal 6a and the second male terminal 6b. In other words, in each busbar 6, the first male terminal 6a and the second male terminal 6b are connected to each other via the bent portion 6c so as to cross each other, specifically, so as to be orthogonal to each other. Specifically, each busbar 6 constitutes a coupling terminal in which the first male terminal 6a that is formed into a bar shape has a first end directly coupled via the bent portion 6c to a first end of the second male terminal 6b that is formed into a bar shape.

The busbar assembly 4 in the first embodiment includes a total of six busbars that includes three first-stage busbars 6A and three second-stage busbars 6B. In the first embodiment, the first-stage busbars 6A are formed to be longer than the second-stage busbars 6B in terms of a length of the first male terminal 6a with reference to the bent portion 6c and a length of the second male terminal 6b with reference to the bent portion 6c. The three first-stage busbars 6A are formed into substantially the same L-shape that are slightly different from each other at, for example, the position and the shape of a locking portion at which the first-stage busbar 6A is locked in the holder 7. Similarly, the three second-stage busbars 6B are formed into substantially the same L-shape that are slightly different from each other at, for example, the position and the shape of a locking portion at which the second-stage busbar 6B is locked in the holder 7. It is noted that, in the descriptions that follow, the first-stage busbars 6A, when they do not need to be differentiated from the second-stage busbars 6B, will be simply referred to as the busbars 6.

The holder 7 holds the busbars 6 in place. The holder 7 is formed generally of, for example, an insulating synthetic resin. The holder 7 stacks the first-stage busbars 6A on the second-stage busbars 6B to hold the first-stage busbars 6A and the second-stage busbars 6B in a stacking direction as a first direction (see, for example, FIGS. 3 and 4). The holder 7 further arranges the first-stage busbars 6A to hold the first-stage busbars 6A at predetermined spaced intervals therebetween in an array direction as a second direction (see, for example, FIGS. 3 and 4). Similarly, the holder 7 arranges the second-stage busbars 6B to hold the second-stage busbars 6B at predetermined spaced intervals therebetween in the array direction as the second direction. The holder 7 holds the busbars 6 in such a positional relation that the first male terminal 6a of each busbar 6 extends in an extension direction as a third direction (see, for example, FIGS. 3 and 4) and the second male terminal 6b of each busbar 6 extends in the stacking direction.

In the first embodiment, the stacking direction, the array direction, and the extension direction are orthogonal to each other. Directional expressions to be mentioned in the following descriptions indicate directions applicable in a condition in which the parts are assembled with each other unless otherwise specified.

The holder 7 in the first embodiment is generally formed into a substantially rectangular parallelepiped shape. The holder 7 includes a plurality of holding recesses 7a, a plurality of locking claws 7b, and a plurality of ribs 7c. The holding recesses 7a are each a recessed groove in which the first male terminal 6a of the busbar 6 is held and that is formed to extend in the extension direction. Three holding recesses 7a are formed on a first side in the stacking direction of the holder 7 to hold the first-stage busbars 6A. Another three holding recesses 7a are formed on a second side in the stacking direction of the holder 7 to hold the second-stage busbars 6B. The locking claws 7b each form a lug at which the first male terminal 6a of each busbar 6 held in the corresponding holding recess 7a is caught. The locking claws 7b are formed at a plurality of places. The ribs 7c are each formed into a rectangular plate serving, for example, to reinforce the holder 7. The ribs 7c will be described in detail later. Each busbar 6 has the first male terminal 6a fitted into the corresponding holding recess 7a and has the locking portion locked at the corresponding locking claw 7b, to be held in the holder 7. The holder 7 holds each busbar 6 in place in such a positional relation that, in a condition in which the first male terminal 6a of each busbar 6 (the first-stage busbars 6A and the second-stage busbars 6B) is held in the corresponding holding recess 7a, the first male terminal 6a of each busbar 6 protrudes on one identical side in the extension direction and the second male terminal 6b of each busbar 6 protrudes on one identical side in the stacking direction. Specifically, the holder 7 holds the busbars 6 such that the first male terminals 6a are arrayed on a first virtual plane and the second male terminals 6b are arrayed on a second virtual plane that is orthogonal to the first virtual plane. In the first embodiment, the holder 7 holds the first-stage busbars 6A such that the first male terminals 6a are arrayed on a first virtual plane P11 and the second male terminals 6b are arrayed on a second virtual plane P12 that is orthogonal to the first virtual plane P11. Similarly, the holder 7 holds the second-stage busbars 6B such that the first male terminals 6a are arrayed on a first virtual plane P21 and the second male terminals 6b are arrayed on a second virtual plane P22 that is orthogonal to the first virtual plane P21. As described previously, the first male terminals 6a and the second male terminals 6b have different lengths from each other between the first-stage busbars 6A and the second-stage busbars 6B. Thus, the first-stage busbars 6A and the second-stage busbars 6B are configured such that, in a condition in which the first-stage busbars 6A and the second-stage busbars 6B are held in the holder 7, the first male terminals 6a have distal ends in the extension direction positioned substantially in alignment with each other, and the second male terminals 6b have distal ends in the stacking direction positioned substantially in alignment with each other.

Reference is made to FIGS. 1, 2, 5, and 6. The male housing 5 is molded integrally with the busbar assembly 4 disposed thereinside. The male housing 5 is electrically insulative. Ends of the busbars 6, specifically, the first male terminals 6a and the second male terminals 6b are exposed from the male housing 5. The male housing 5 is generally formed, for example, of an insulative synthetic resin. The male housing 5 is molded integrally with the busbar assembly 4 by, for example, insert molding. Specifically, the male assembly 2 is molded, for example, as follows. The busbar assembly 4 is placed in a mold for insert molding and an insulative resin is injected into a space around the busbar assembly 4, so that the busbar assembly 4 is integrated with the male housing 5 formed of the resin.

The male housing 5 in the first embodiment is formed into a substantially rectangular columnar shape having rounded corners. The male housing 5 is formed so as to have a longitudinal axis extending in the extension direction of the busbar assembly 4. The male housing 5 has a first fitting space 51 and a second fitting space 52. The first fitting space 51 is disposed in an end face on a first side in the extension direction (longitudinal direction) and the second fitting space 52 is disposed in a face on a first side in the stacking direction.

The first fitting space 51 is an opening formed in the end face (the end face on the side from which the first male terminals 6a protrude) of the male housing 5 on the first side in the extension direction. The first fitting space 51 constitutes a hood in which the first male terminals 6a are exposed and into which the first mating member 101 to be electrically connected to the first male terminals 6a can be fitted. The first fitting space 51 is molded into a space that is sized and shaped to allow the connector housing 101a of the first mating member 101 to be fitted. In the first embodiment, the first fitting space 51 is molded into a substantially rectangular columnar shape having rounded corners. Each of the first male terminals 6a protrudes to be exposed in the first fitting space 51. Each of the first male terminals 6a has a distal end disposed inside the first fitting space 51.

The second fitting space 52 is an opening molded in the face (the face on the side from which the second male terminals 6b protrude) of the male housing 5 on the first side in the stacking direction. The second fitting space 52 constitutes a hood in which the second male terminals 6b are exposed and into which the female assembly 3 to be electrically connected to the second male terminals 6b and to be described later can be fitted. The second fitting space 52 is molded, in the face on the first side in the stacking direction, on an end on a second side in the extension direction, specifically, on a side opposite to the side on which the first fitting space 51 is molded. The second fitting space 52 is molded into a space that is sized and shaped to allow a female housing 9 of the female assembly 3 to be described later to be fitted. In the first embodiment, the second fitting space 52 is molded into a substantially rectangular columnar shape having rounded corners. Each of the second male terminals 6b protrudes to be exposed in the second fitting space 52. Each of the second male terminals 6b has a distal end disposed inside the second fitting space 52.

Reference is made to FIGS. 2, 7, and 8. The female assembly 3 includes a plurality of connecting units 8, the female housing 9, a first packing 10, and a second packing 11. The connecting units 8 are held in the female housing 9 and the first packing 10 and the second packing 11 are fitted on an outer peripheral surface of the female housing 9 to constitute the female assembly 3.

The connecting units 8 each include a first female terminal 8a and a second female terminal 8b integrated with each other and each are electrically conductive. A corresponding one of the male terminals 102b of the second mating member 102 is inserted into and electrically connected to a corresponding one of the first female terminals 8a. A corresponding one of the second male terminals 6b is inserted into and electrically connected to a corresponding one of the second female terminals 8b. Each of the connecting units 8 is generally formed, for example, of an electrically conductive metal. Electrically conductive plating, for example, is applied to the surface of each of the connecting units 8. The first female terminal 8a and the second female terminal 8b clamp the male terminal 102b and the second male terminal 6b, respectively, and are formed by, for example, press-working into each connecting unit 8 that can be electrically connected to the second male terminal 6b and the male terminal 102b. Each of the connecting units 8 is generally formed into a bar shape having an end on a first side at which the first female terminal 8a is formed and an end on a second side at which the second female terminal 8b is formed. In other words, each of the connecting units 8 constitutes a coupling terminal in which one end of the first female terminal 8a is linearly and directly coupled to one end of the second female terminal 8b. In the first embodiment, the female assembly 3 includes six connecting units 8 that correspond in number to the first male terminals 6a of the busbar 6.

The female housing 9 is a holding member that holds the connecting units 8 and is generally formed, for example, of an insulative synthetic resin. The female housing 9 fits into the second fitting space 52 to hold the connecting units 8 in a condition in which the second male terminals 6b and the second female terminals 8b are electrically connected to each other. The female housing 9 is formed to have a part that can be fitted into the second fitting space 52. In the first embodiment, the female housing 9 is formed into a substantially rectangular columnar shape with rounded corners and has a first end side that can be fitted into the second fitting space 52. The female housing 9 has a plurality of housing holes 9a, a first mounting groove 9b, a second mounting groove 9c, a plurality of first locking claws 9d, and a plurality of second locking claws 9e.

The housing holes 9a hold the connecting units 8. The housing holes 9a pass through a main body portion of the female housing 9 in the stacking direction. The connecting units 8 are press-fitted into the housing holes 9a from a first side in the stacking direction, specifically in the first embodiment, from the side on which the female housing 9, when fitted into the second fitting space 52, is disposed inside the second fitting space 52. In this case, the connecting units 8 are press-fitted into the housing holes 9a from the first female terminals 8a side facing the housing holes 9a. This mounting procedure results in the following. When the female housing 9 is fitted in the second fitting space 52 in a condition in which the connecting units 8 are held in the housing holes 9a, the second female terminals 8b are disposed on a side of the second fitting space 52 and the first female terminals 8a are disposed on a side opposite to the second fitting space 52. Additionally, the housing holes 9a are formed such that the connecting units 8 do not fall from the side of the first female terminals 8a. The female housing 9 has six housing holes 9a that correspond in number to the connecting units 8.

The first mounting groove 9b is a recessed groove in which the first packing 10 is fitted. The first mounting groove 9b is formed annularly in the main body portion of the female housing 9 along the extension direction and the array direction. The second mounting groove 9c is a recessed groove in which the second packing 11 is fitted. The second mounting groove 9c is formed annularly in the main body portion of the female housing 9 along the extension direction and the array direction. With the female housing 9 fitted in the second fitting space 52 in the male housing 5, the first mounting groove 9b is disposed on the side of the second fitting space 52 and the second mounting groove 9c is disposed on the side opposite to the second fitting space 52.

The first locking claws 9d each form a lug with which the female housing 9 is locked in the male housing 5 in a condition in which the female housing 9 is fitted in the second fitting space 52 in the male housing 5. The first locking claws 9d are formed at a plurality of places. The first locking claws 9d are engaged with predetermined portions of the male housing 5 to lock the female housing 9 in the male housing 5. The second locking claws 9e each form a lug with which the female housing 9 is locked in the housing 102a of the second mating member 102. The second locking claws 9e are formed at a plurality of places. The second locking claws 9e are engaged with predetermined portions of the housing 102a to lock the female housing 9 in the housing 102a. The first locking claws 9d and the second locking claws 9e are formed between the first mounting groove 9b and the second mounting groove 9c in the stacking direction.

The first packing 10 and the second packing 11 are each a sealing member formed, for example, of an insulative synthetic resin. The first packing 10 and the second packing 11 are each an elastic member having elasticity and are each formed annularly. The first packing 10 is mounted in the first mounting groove 9b and the second packing 11 is mounted in the second mounting groove 9c. In a condition in which the female housing 9 is fitted in the second fitting space 52 in the male housing 5, the first packing 10 is disposed between and in tight contact with the female housing 9 and the male housing 5 to prevent entry of water from an outside into contact points between the second male terminals 6b and the second female terminals 8b. In a condition in which the second mating member 102 is assembled to the female housing 9, the second packing 11 is disposed between and in tight contact with the housing 102a and the male housing 5 to prevent entry of water from an outside into contact points between the first female terminals 8a and the male terminals 102b.

The connector 1 having the configurations as described above is generally formed by the female assembly 3 being assembled to the male assembly 2. Specifically, the connector 1 is generally formed by the female housing 9 that constitutes part of the female assembly 3 being fitted and locked in the second fitting space 52 in the male housing 5 that constitutes part of the male assembly 2 to electrically connect the second male terminals 6b that constitute part of the male assembly 2 to the second female terminals 8b that constitute part of the female assembly 3. As such, the connector 1 can properly achieve a male female relay connector having a bent, substantially L-shape by the male assembly 2 and the female assembly 3 separately configured and then assembled with each other.

As a comparative example, for example, a connector may disuse the female assembly 3, the first female terminals 8a instead of the second male terminals 6b may be integrally formed in the busbars 6, and the busbars 6 and the male housing 5 may be insert-molded. This comparative example can lead to the following situation. Specifically, in the connector according to the comparative example, when part of the first female terminals 8a is embedded and integrally fixed in the male housing 5, a resin leak may occur from the first female terminals 8a when the busbars 6 including the first female terminals 8a are integrally molded with the male housing 5. Meanwhile, in the connector according to the comparative example, when an attempt is made to fix the busbars 6 with the first female terminals 8a completely exposed from the male housing 5, the mold for insert molding is difficult to release and the first female terminals 8a tend to deviate from their correct positions (deviation).

In contrast, in the connector 1 according to the first embodiment, the busbars 6 including the first male terminals 6a and the second male terminals 6b are integrally molded with the male housing 5 to constitute the male assembly 2. This arrangement in the connector 1 of the first embodiment achieves the following. Specifically, even when the busbars 6 including the bent portions 6c formed therein are difficult to later fit inside the male housing 5, the male assembly 2 can be built through integral molding of the busbars 6 and the male housing 5. Meanwhile, in the connector 1, the connecting units 8 including the first female terminals 8a and the second female terminals 8b are press-fitted into the female housing 9 to build the female assembly 3. This arrangement employed in the connector 1 allows the female assembly 3 to be built, not by integral molding, but by later fitting the connecting units 8 inside the female housing 9. The connector 1 can then be generally built by assembling the male assembly 2 and the female assembly 3 that are each separately built.

Reference is made to FIGS. 2, 3, and 4. In the holder 7 in the first embodiment, the ribs 7c correctly position the busbars 6 and form lightened portions 53 in the male housing 5 during molding of the male housing 5, to improve moldability of the male housing 5.

The ribs 7c are formed in plurality. The ribs 7c each extend in the stacking direction. In the first embodiment, the ribs 7c are formed into, for example, substantially rectangular walls, rectangular columns, or bent walls so as to discontinuously surround the holding recesses 7a at spaced intervals.

When the busbar assembly 4 is placed in the mold for insert molding in order to insert-mold the male assembly 2, the ribs 7c fix the busbar assembly 4 including the busbars 6 generally in a predetermined position in the mold. When the insulative resin is injected into a space around the busbar assembly 4, the ribs 7c function as protective walls that prevent the injected resin from directly contacting the busbars 6, to prevent the busbars 6 from being deviated or displaced by a resin pressure applied during the injection of the resin.

After the molding of the male housing 5, the ribs 7c form the lightened portions 53 in the male housing 5. The lightened portions 53 are portions of walls that are unnecessary in terms of the structure of the male housing 5 and thus are thinned from the inside, while maintaining a required outside shape of the male housing 5. The lightened portions 53 typically have wall thicknesses smaller than thicknesses of other portions of the wall of the male housing 5. Specifically, the holder 7 in the first embodiment includes the ribs 7c that serve as not only the protective walls during injection of the resin for the molding of the male housing 5, but also ribs for thinning the wall of the male housing 5.

In accordance with the first embodiment described above, the connector 1 includes the electrically conductive busbar 6, the holder 7 that holds the busbar 6, and the male housing 5 that houses therein the holder 7 and the busbar 6 held in the holder 7, which is integrally molded with the holder 7 and the busbar 6 to be electrically insulative, and from which the end of the busbar 6 is exposed. The holder 7 includes the ribs 7c that correctly position the busbar 6 and form the lightened portions 53 in the male housing 5 during molding of the male housing 5. The lightened portions 53 have a wall thickness smaller than other portions of the male housing 5.

Thus, in the connector 1, the holder 7 that holds the busbar 6 and that is integrally molded with and disposed inside the male housing 5 includes the ribs 7c that correctly position the busbar 6 and form the lightened portions 53 in the male housing 5 during the molding of the male housing 5. This arrangement allows the connector 1 to reliably position the busbar 6 in predetermined positions using the ribs 7c during the molding of the male housing 5. Additionally, because of the lightened portions 53 formed by the ribs 7c in the male housing 5, the connector 1 can prevent sink and void from occurring in the male housing 5 during the molding of the male housing 5. As a result, the connector 1 can, for example, improve moldability without the need to change the desired appearance shape.

In accordance with the first embodiment described above, the connector 1 includes the electrically conductive connecting units 8 and the female housing 9 that holds the connecting units 8. The busbar 6 includes the first male terminal 6a and the second male terminal 6b integrally formed with each other via the bent portion 6c. The busbar 6 includes a plurality of busbars 6. The holder 7 holds the plurality of busbars 6 such that the first male terminals 6a are arrayed on the first virtual planes P11 and P21 and the second male terminals 6b are arrayed on the second virtual planes P12 and P22 that are orthogonal to the first virtual planes P11 and P21. The male housing 5 has the first fitting space 51 in which the first male terminals 6a are exposed and into which the first mating member 101 to be electrically connected to the first male terminals 6a can be fitted, and the second fitting space 52 in which the second male terminals 6b are exposed. The connecting units 8 integrate the first female terminals 8a into which the second mating member 102 is inserted and to which the second mating member 102 is electrically connected, with the second female terminals 8b into which the second male terminals 6b are inserted and to which the second male terminals 6b are electrically connected. The female housing 9 fits into the second fitting space 52 and holds the connecting units 8 in a condition in which the second male terminals 6b are electrically connected to the second female terminals 8b.

Thus, in the connector 1, the female housing 9 fits into the second fitting space 52 in the male housing 5 to hold the connecting units 8 in place in a condition in which the second male terminals 6b of the busbars 6 molded inside and integrally with the male housing 5 are electrically connected to the second female terminals 8b of the connecting units 8 molded separately from the male housing 5. Additionally, in the connector 1, while the first mating member 101 fits into the first fitting space 51 in the male housing 5 to be electrically connected to the first male terminals 6a of the busbars 6, the second mating member 102 is inserted into the first female terminals 8a of the connecting units 8 to be electrically connected to the first female terminals 8a. As a result, the connector 1 can electrically connect the mating members (the first mating member 101 and the second mating member 102) across both sides of the bent portions 6c disposed inside the male housing 5. Furthermore, the connector 1, having a configuration including the first male terminals 6a and the second male terminals 6b in plurality arranged so as to cross each other, can properly achieve a configuration of electrically connecting the mating members (the first mating member 101 and the second mating member 102) across both sides of the bent portions 6c disposed inside the male housing 5 as described above.

In the connector 1, the male assembly 2 that includes the busbars 6 and the male housing 5, and the female assembly 3 that includes the connecting units 8 and the female housing 9 are built separately as separate structures and the separate structures are later assembled with each other. Through this approach, the connector 1 can properly achieve a configuration of electrically connecting the mating members (the first mating member 101 and the second mating member 102) across both sides of the bent portions 6c disposed inside the male housing 5. In this configuration, the connector 1 can improve moldability of the male housing 5 as described above.

The connector according to the first embodiment has been presented by way of example only and is not intended to limit the scope of the invention. Various changes in form and detail may be made therein without departing from the spirit and scope of the invention.

The first embodiment, while being described on the basis that the stacking direction, the array direction, and the extension direction are orthogonal to each other, is not limiting. The connector 1, while being described as a bent, substantially L-shaped male female connector, and each of the busbars 6, while being described as including the bent portion 6c formed from the rectangular wire rod being bent into a substantially L-shape, are not limiting. The connector 1 is not necessarily required to include the bent portions 6c. The connector 1 is not necessarily required to incorporate the configuration in which the male assembly 2 and the female assembly 3 are separately built to form the individual separate structures that are then assembled with each other.

In the connector according to the first embodiment of the present invention, the holder that holds the busbars and that is integrally molded with and disposed inside the housing includes the ribs that correctly position the busbars and form the lightened portions in the housing. This arrangement allows the connector to reliably position the busbars in predetermined positions using the ribs during the molding of the housing. Additionally, because of the lightened portions formed by the ribs in the housing, the connector can prevent sink and void from occurring in the housing during the molding of the housing. As a result, the connector can achieve an effect of improving moldability.

### Second Embodiment

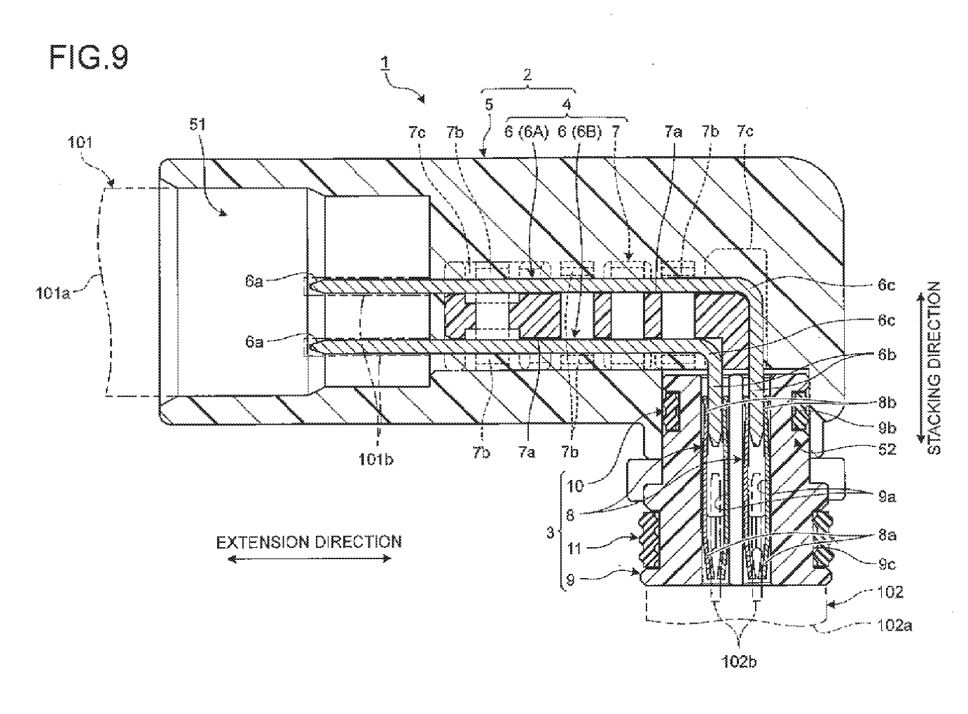

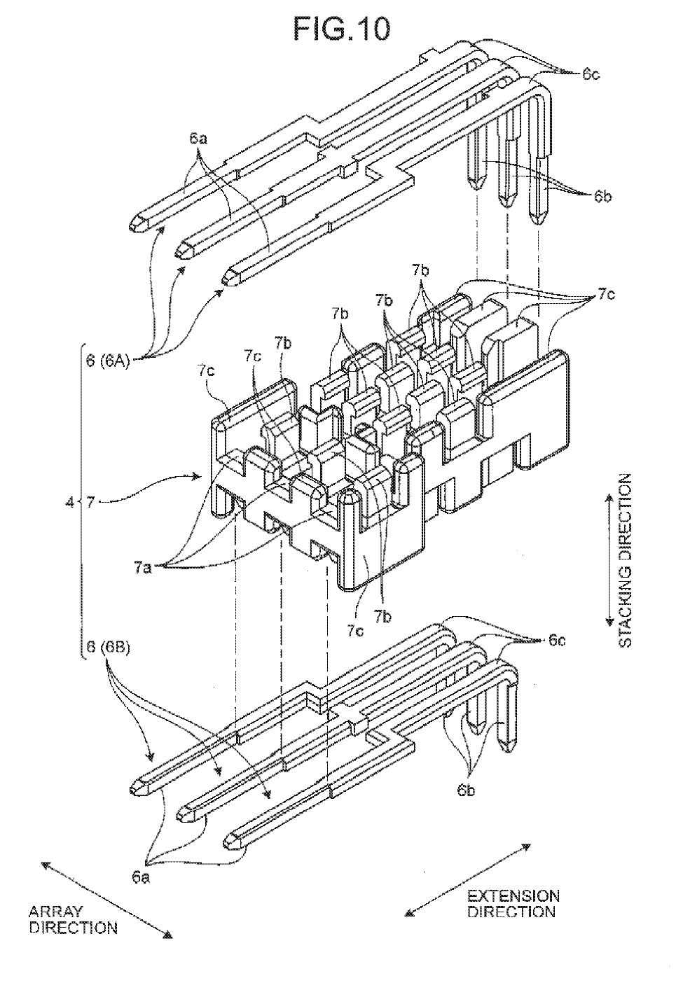

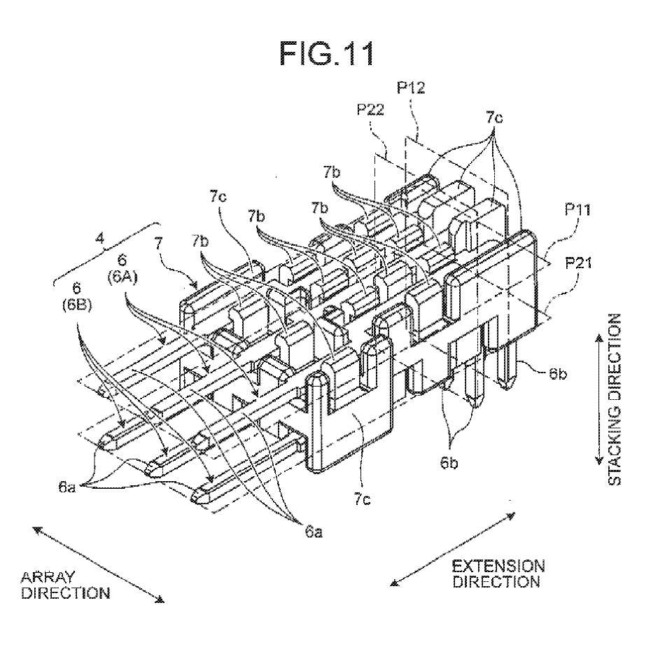

FIG. 1 is a perspective view of a schematic configuration of a connector according to a second embodiment of the present invention. FIG. 9 is a sectional view of the connector according to the second embodiment, taken along line A-A. FIG. 10 is an exploded perspective view of a busbar assembly of the connector according to the second embodiment. FIG. 11 is a perspective view of the busbar assembly of the connector according to the second embodiment. FIG. 5 is a view from the direction of arrow B illustrated in FIG. 1. FIG. 6 is a view from the direction of arrow C illustrated in FIG. 1. FIG. 7 is an exploded perspective view of a female assembly of the connector according to the second embodiment. FIG. 8 is a perspective view of the female assembly of the connector according to the second embodiment.

Of the drawings mentioned above, FIGS. 1 and 5 to 8 illustrate configurations common to the first and second embodiments. FIGS. 9 to 11 according to the second embodiment correspond to FIGS. 2 to 4 according to the first embodiment, respectively. Thus, the descriptions of the connector according to the first embodiment are applicable to the connector in the second embodiment and descriptions of similarities will not be reiterated.

The connector 1 according to the second embodiment includes a busbar 6, a male housing 5, a connecting unit 8, and a female housing 9. The busbar 6 includes a first male terminal 6a and a second male terminal 6b integrally formed with each other via a bent portion 6c. The busbar 6 is electrically conductive. The male housing 5 houses therein the busbar 6 and is molded integrally with the busbar 6. The male housing 5 has a first fitting space 51 and a second fitting space 52. The first male terminal 6a is exposed in the first fitting space 51. A first mating member 101 to be electrically connected to the first male terminal 6a can be fitted into the first fitting space 51. The second male terminal 6b is exposed in the second fitting space 52. The male housing 5 is electrically insulative. The connecting unit 8 includes a first female terminal 8a and a second female terminal 8b integrated linearly with each other. A second mating member 102 is inserted in and electrically connected to the first female terminal 8a. The second male terminal 6b is inserted in and electrically connected to the second female terminal 8b. The connecting unit 8 is electrically conductive. The female housing 9 fits into the second fitting space 52 to hold the connecting unit 8 in a condition in which the second male terminal 6b is electrically connected to the second female terminal 8b.

Thus, in the connector 1, the female housing 9 fits into the second fitting space 52 in the male housing 5 to hold the connecting unit 8 in place in a condition in which the second male terminal 6b of the busbar 6 formed inside and integrally with the male housing 5 is electrically connected to the second female terminal 8b of the connecting unit 8 formed separately from the male housing 5. Additionally, in the connector 1, while the first mating member 101 fits into the first fitting space 51 in the male housing 5 to be electrically connected to the first male terminal 6a of the busbar 6, the second mating member 102 is inserted into the first female terminal 8a of the connecting unit 8 to be electrically connected to the first female terminal 8a. As a result, the connector 1 can electrically connect the mating members (the first mating member 101 and the second mating member 102) across both sides of the bent portion 6c disposed inside the male housing 5.

In the connector 1, the male assembly 2 that includes the busbar 6 and the male housing 5, and the female assembly 3 that includes the connecting unit 8 and the female housing 9 are built separately as separate structures and the separate structures are later assembled with each other. Through this approach, the connector 1 can properly achieve a configuration of electrically connecting the mating members (the first mating member 101 and the second mating member 102) across both sides of the bent portion 6c disposed inside the male housing 5.

In accordance with the connector 1 described above, the busbar 6 includes a plurality of busbars 6. The busbars 6 are arranged such that the first male terminals 6a are arrayed on first virtual planes P11 and P21 and the second male terminals 6b are arrayed on second virtual planes P12 and P22 that are orthogonal to the first virtual planes P11 and P21. As a result, in a configuration in which the first male terminals 6a and the second male terminals 6b are arrayed so as to cross each other, the connector 1 can properly achieve a configuration of electrically connecting the mating members (the first mating member 101 and the second mating member 102) across both sides of the bent portions 6c disposed inside the male housing 5 as described above.

The second embodiment, while being described on the basis that a stacking direction, an array direction, and an extension direction are orthogonal to each other, is not limiting. The connector 1, while being described as a bent, substantially L-shaped male female connector, and each of the busbars 6, while being described as including the bent portion 6c formed from the rectangular wire rod being bent into a substantially L-shape, are not limiting. The busbar 6 is required only to include the bent portion 6c and does not necessarily have to be substantially L-shaped. The busbar 6 may, for example, be substantially gable-shaped.

The connector according to the second embodiment includes:

a busbar having electrical conductivity that includes a first male terminal and a second male terminal integrally formed each other via a bent portion;

a male housing having insulative property that houses therein a busbar and that is molded integrally with the busbar, the male housing having a first fitting space in which the first male terminal is exposed and in which a first mating member to be electrically connected to the first male terminal can be fitted, and a second fitting space in which the second male terminal is exposed;

a connecting unit having electrical conductivity that includes a first female terminal in which a second mating member is inserted and to which the second mating member is electrically connected, and a second female terminal in which the second male terminal is inserted and to which the second male terminal is electrically connected, the first female terminal and the second female terminal being integrated linearly with each other; and

a female housing that fits into the second fitting space to hold the connecting unit in a condition in which the second male terminal is electrically connected to the second female terminal.

In the connector described above, preferably, the busbar includes a plurality of busbars and the busbars are arranged such that the first male terminals are each arrayed on a first virtual plane and the second male terminals are each arrayed on a second virtual plane that is orthogonal to the first virtual plane.

In the connector according to the embodiment of the present invention, the female housing fits into the second fitting space in the male housing to hold the connecting unit in place in a condition in which the second male terminal of the busbar formed inside and integrally with the male housing is electrically connected to the second female terminal of the connecting unit formed separately from the male housing. Additionally, in the connector, while the first mating member fits into the first fitting space in the male housing to be electrically connected to the first male terminal of the busbar, the second mating member is inserted into the first female terminal of the connecting unit to be electrically connected to the first female terminal. As a result, the connector achieves an effect of being capable of electrically connecting the mating members across both sides of the bent portion disposed inside the male housing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a busbar having electrical conductivity that includes a first male terminal and a second male terminal integrally formed each other via a bent portion;
a male housing having insulative property that houses therein a busbar and that is molded integrally with the busbar, the male housing having a first fitting space in which the first male terminal is exposed and in which a first mating member to be electrically connected to the first male terminal can be fitted, and a second fitting space in which the second male terminal is exposed;
a connecting unit having electrical conductivity that includes a first female terminal in which a second mating member is inserted and to which the second mating member is electrically connected, and a second female terminal in which the second male terminal is inserted and to which the second male terminal is electrically connected, the first female terminal and the second female terminal being integrated linearly with each other; and
a female housing that fits into the second fitting space to hold the connecting unit in a condition in which the second male terminal is electrically connected to the second female terminal.

2. The connector according to claim 1, wherein
the busbar includes a plurality of busbars and the busbars are arranged such that the first male terminals are each arrayed on a first virtual plane and the second male terminals are each arrayed on a second virtual plane that is orthogonal to the first virtual plane.
